(19) United States
(12) Patent Application Publication
(10) Pub. No.: US 2019/0351683 A1
(43) Pub. Date: Nov. 21, 2019

(54) DRYING PRINTER FLUID

(71) Applicant: HP SCITEX LTD., Netanya (IL)

(72) Inventors: Alex Veis, Netanya (IL); Yubai Bi, San Diego, CA (US)

(73) Assignee: HP SCITEX LTD., Netanya (IL)

(21) Appl. No.: 16/293,291

(22) Filed: Mar. 5, 2019

(30) Foreign Application Priority Data
May 17, 2018 (EP) 18173016.9

(51) Int. Cl. B41J 11/00

(52) U.S. Cl. CPC B41J 11/002

(57) ABSTRACT

A method comprises applying to a substrate a layer of substantially clear solvent-based printer fluid. The printer fluid comprises an ultraviolet light absorbing substance. The method comprises irradiating the applied layer of printer fluid with an ultraviolet light to heat the solvent and cause evaporation of the solvent. The waveband of the radiation is such that heating of the solvent is substantially due to heat transfer from the ultraviolet light absorbing substance in the printing fluid.

### BACKGROUND

In print operations, printing fluids such as inks, fixers, varnishes primers and coatings may be applied to a substrate. A substrate bearing such a fluid may be dried, for example using hot air convection, infrared dryers, near infrared dryers, acoustic dryers, gas burners, radio frequency dryers, microwave dryers or the like.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 shows absorption spectra for example aqueous inks and an example infrared light emission spectrum.

FIG. 2 is a flow chart representation of an example method.

FIG. 3 shows plots of absorbance and transmittance for example ultraviolet light absorbing substances.

FIG. 4 is a flow chart representation of another example method.

FIG. 5 is a schematic representation of an example print apparatus.

FIG. 6 is a schematic representation of another example print apparatus.

### DETAILED DESCRIPTION

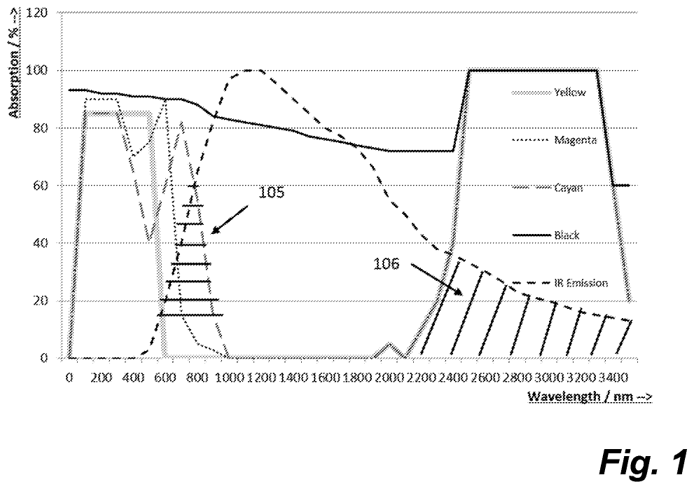

FIG. 1 illustrates the absorption efficiency as a percentage of the incident radiation energy for each of a yellow, magenta, cyan and black aqueous, i.e. water based, ink against wavelength of incident radiation. For all but the black ink, there are substantially two absorption zones, a first absorption zone, up to around 1000 nm, where the colorant absorbs radiation with relatively high efficiency, and a second absorption zone, above approximately 2200 nm, where the water component of the ink absorbs radiation, in the infrared (IR) part of the electromagnetic spectrum.

In the second absorption zone, above approximately 2200 nm, the absorption efficiencies of the yellow, magenta and cyan inks are merged and in this absorption zone absorption is materially due to the solvent, in this case water.

An infrared heat source in a printer ink dryer unit may, for example, emit radiation in the region of 600 nm-3400 nm, with a peak at around 1200 nm. FIG. 1 shows an emission spectrum of such an example source, which will be referred to herein as an IR source. The IR source dries pigment-comprising aqueous inks substantially by being absorbed by the solvent, water, in the region above around 2200 nm. FIG. 1 shows the overlap of the IR emission spectrum with a water absorption region, which is shown with figure reference 106. It can be seen that the peak of the example IR emission spectrum, at approximately 1200 nm, does not lie in this region of the spectrum. The example IR source also overlaps an absorption region 105 for magenta, below 1000 nm, but does not substantially overlap absorption regions for other colored inks in this region. As such, the example IR heat source does not result in efficient heating of either the non-black colorants or the water, meaning the energy absorption efficiency is low, and correspondingly the power consumed in drying processes is relatively high. That is, the example IR source therefore results in inefficient drying of the pigment-comprising aqueous inks and results in imbalanced heating of inks of different colors. For example, in such a situation for inks of approximately 2.5 μm (microns) to 3.5 μm in thickness, cyan ink may absorb around 30% of the incident energy, while magenta and yellow inks absorb even less.

Moreover, the black ink has a markedly higher absorption efficiency than other colors overs this IR range, absorbing around 75%-95% of incident radiation. This imbalance can mean that a substrate underlying a black ink may overheat before, for example, a region of yellow ink on the same substrate dries—since yellow ink has a colorant absorption efficiency which is low in the IR region. This imbalance can cause damage to a substrate.

For the sake of comparison, a fluid which absorbs 30% of the incident energy, will use 2.5 times the energy as would produce the same evaporation for a fluid with a 75% absorption efficiency, resulting in additional energy consumption and associated costs, and in general more expensive and/or larger apparatus.

In an example, an ultraviolet (UV) light source may be used to irradiate a solvent-based printing fluid comprising a pigment, such as the colored aqueous inks discussed above. In this example, the pigment may absorb UV light causing heating and evaporation of the solvent to dry the printer fluid. As referred to herein, a solvent may refer to any suitable solvent for use in a printing fluid, including water, organic solvents, or a combination thereof. In examples, if UV light is used rather than IR light, the energy is efficiently absorbed by the pigment of the colored ink, and the pigment is not evaporated. Since it is not the water being heated, as is the case for IR drying, the energy absorption, and correspondingly the evaporation rate, may stay at a substantially constant level as the ink dries and there is less water to heat.

UV light has also been used previously in some printing processes, for example to cause polymerization of inks, which may be referred to as curing, the dose of energy supplied in such a process is low, compared to the energy involved in example methods involving evaporating of a solvent from an ink layer. When used to cause polymerization, a broadband source, e.g. a light source with a plurality of intensity peaks over a range of 200 nm to 1500 nm, may be employed, although, in some examples, one or more UV LED emitting a narrow band of radiation may be employed.

Print operations may use clear solvent-based printer fluids, for example to print a coating, a primer, or a varnish. In some examples, the use of clear fluids in a print operation may be in addition to colored printing fluids such as those discussed above. Depending on its function, a clear printer fluid may be applied in isolation, or may be applied with other types of printer fluids, such as colored printing fluids, and the clear printer fluid may be printed before or after any such other types of printer fluids.

A substantially clear water-based printing fluid may have an absorption band which is similar in the IR range to that shown in FIG. 1 for colored ink. That is, a clear water-based printing fluid may absorb IR radiation above approximately 2200 nm, by virtue of the absorption properties of water present in the clear fluid. However, the clear printing fluid may not appreciably absorb UV light. This means that, in the above example, a UV light source may be used to dry the colored printing fluid, while a UV light source is unable to dry the clear printing fluid and an IR light source, for example, is used instead.

Example methods and substances described herein provide for a clear print fluid comprising a UV absorbing substance which allows for drying of clear print fluids by UV light. This may provide for drying of clear print fluids and colored printing fluids by the same UV light source, for example by a drying unit comprising one or more UV LEDs. As such, efficient drying can be achieved when compared to usage of a separate drying unit for colored fluids and clear fluids. Allowing replacing of an IR drying apparatus with a UV apparatus which can dry clear and colored printed fluids may provide for reducing expense and/or the size or apparatus used.

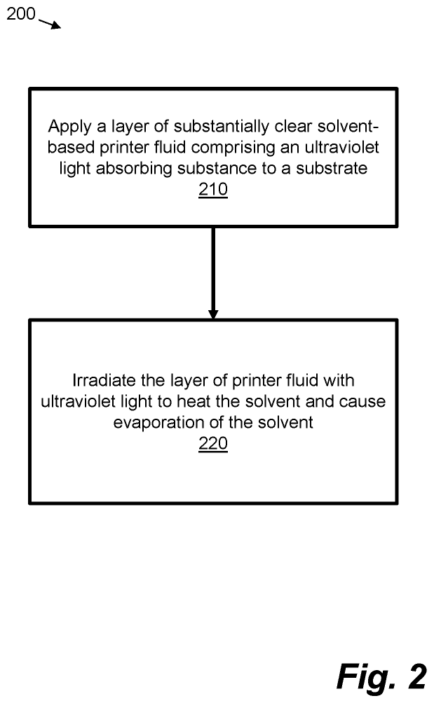

FIG. 2 is a flowchart of an example method 200 for applying a layer of printer fluid to a substrate and drying the printer fluid. The method 200 comprises, in block 210, applying to a substrate a layer of substantially clear solvent-based printer fluid comprising an ultraviolet light (UV) absorbing substance. The substrate may be any substrate suitable for applying a layer of printer fluid to. For example, the substrate may be a medium, such as paper or cardboard. In some examples, the substrate may be substantially planar. The clear printer fluid in some examples may be a coating, a varnish or primer, or any other substantially clear printing fluid used during a print operation.

The method 200 of FIG. 2 comprises, in block 220, irradiating the applied layer of substantially clear solvent-based printer fluid comprising an ultraviolet light absorbing substance with ultraviolet light to cause evaporation of the solvent from the printer fluid. In examples, the waveband of radiation is such that, in block 220, the ultraviolet light absorbing substance is heated by absorbing UV light. In block 220, the heat may transfer from the UV absorbing substance to the solvent fluid to cause evaporation of the solvent and drying of the printer fluid.

The ultraviolet light absorbing substance may absorb UV light with wavelengths less than or equal to approximately 420 nm. In some examples, the substantially clear solvent-based printer fluid may comprise more than one type of ultraviolet light absorbing substance. Examples of ultraviolet light absorbing substances will now be described in further detail.

In some examples, a UV light absorbing substance used in an example method described herein may be substance with substantial solubility in water, which may be referred to as a water-soluble substance. In some examples, a UV light absorbing substance used in an example method described herein may be a substance with a substantial solubility in an organic solvent, such as an organic solvent which may form the base of a clear printing fluid.

Example organic solvents suitable for use in an example printing fluid include aliphatic hydrocarbons, aromatic hydrocarbon, e.g. halogenated hydrocarbons, such as of the benzene series, dialkyl and cyclic ethers, glycol ethers, polyalkylene glycols, polyalkylene glycol ethers, alcohols,such as mono- and poly-hydric alcohols, esters, ketones, amides, nitrogen containing heerocyclic compounds, solubilizing ink vehicle components, and monomers, such as acrylate monomers, as well as mixtures thereof. Example solvents include heptane, octane, nonane, decane, Toulene, xylene, petroleum spirit, isopropyl alcohol, isopropyl acetate, methyl ethyl ketone, methylcyclohexanone, methoxypropanol, ethoxypropanol etc. The above example organic solvents may be used in printing fluids not comprising water. In some examples where a printing fluid comprises water and an organic solvent a solvent which is miscible with water may be used, and may be referred to as a co-solvent. In examples, a suitable miscible co-solvent may comprise a glycol, such as propylene glycol. Further examples of suitable co-solvents are given below.

In some examples, a UV light absorbing substance used in an example method described herein may be a substance with low solubility in water, for example a substance which is substantially not soluble in water, which may be referred to as a non-water-soluble substance. In some examples where the UV absorbing substance is soluble in an organic solvent, the substance may be substantially not soluble in water. In some examples, a non-water-soluble UV light absorbing substance may be dispersible in water, and examples of such substances will be discussed below.

In examples, the type of UV absorbing substance or substances in a printing fluid may depend on the type of printing fluid. For example, the type of UV absorbing substance used may depend on the type of solvent the printing fluid comprises. For example, for an aqueous printing fluid, such as an aqueous ink, at least one water-soluble UV absorbing substance may be used. In examples, for a printing fluid comprising a different type of solvent, such as an organic solvent, a non-water-soluble UV absorbing substance may be used. In some examples, a water-dispersible UV absorbing substance may be used in an aqueous printing fluid, such as an aqueous ink.

In examples, one or more UV absorbing substances may be used in a printing fluid. In some examples, more than one UV absorbing substance of one type may be used in a printing fluid, or more than one type of UV absorbing substance may be used in a printing fluid, or more than one type of UV absorbing substance of more than one type may be used in a printing fluid. For example, an aqueous printing fluid may comprise a water-soluble UV absorbing substance, and a dispersible non-water-soluble UV absorbing substance. An example organic solvent-based printing fluid may comprise more than one non-water-soluble UV absorbing substance.

In examples, the type of printing fluid may differ depending on the intended function of the printing fluid. For example, water-based printing fluid, such as water-based ink, may be used in analog printing methods, such as flexographic printing, and in digital printing methods, such as piezo electric printing, and thermal inkjet printing. In other examples, an organic solvent-based printing fluid may be used in analog printing methods such as offset lithography, or flexographic printing, or in digital printing methods such as piezo electric printing, or thermal inkjet printing.

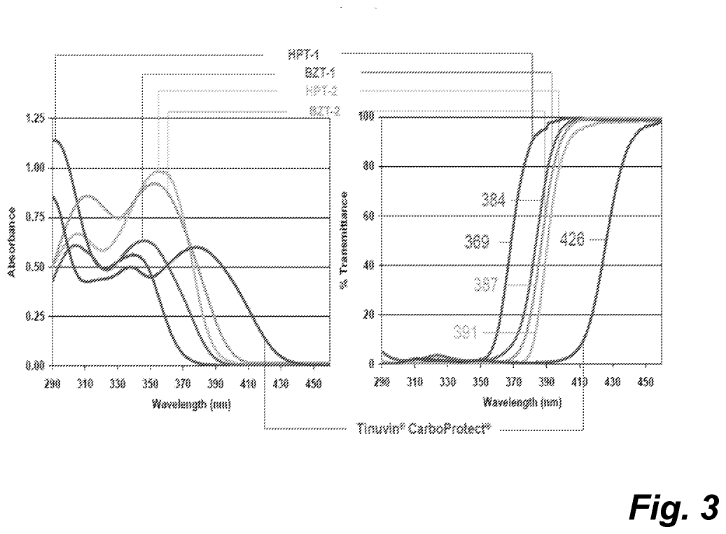

FIG. 3 shows absorbance and transmittance spectra against wavelength of incident ultraviolet light for a plurality of example ultraviolet light absorbing substances. The UV absorbing substances shown in FIG. 3 are examples of substantially non-water-soluble substances. These substances may, in examples, be used in a printing fluid comprising, a non-water solvent, such as an organic solvent, such as example organic solvents listed herein. The example ultraviolet light absorbing substances for which spectra are shown in FIG. 3 are: Hydroxyphenyl Triazine-1 (HPT-1), Hydroxyphenyl Triazine-2 (HPT-2), Benzotriazole-1 (BTZ-1), Benzotriazole-2 (BTZ-2), and Tinuvin® Carboprotect®, containing red-shifted benzotriazole. The data in these plots is for these substances as distributed by BASF SE®.

Further examples of UV absorbing substances for use in an example method of drying an organic solvent-based printing fluid are shown in Table 1. In Table 1, the CAS column denotes the unique numerical identifier assigned to each substance by the Chemical Abstracts Service. As can be seen from Table 1, some of the example substances included therein are UV absorbers based on 2-(2-hydroxyphenyl)-benzotriazole while others of the example substances are UV absorbers based on 2-hydroxyphenyl-s-triazine. The column physical form gives the physical form of the substances at room temperature and pressure.

TABLE 1

| | | | | Molar mass | Melting point |
|---|---|---|---|---|---|
| Product name | CAS | Chemistry | Physical form | [g/mol] | [° C.] |
| 2-(2-hydroxyphenyl)- | | | | | |
| benzotriazole based UV | | | | | |
| absorbers | | | | | |
| Tinuvin ® 109 | 83044-89-7 | BTZ-Cl | liquid | 486 | — |
| | 83044-90-0 | | | | |
| Tinuvin ® 1130 | 104810-47-1 | BTZ | liquid | mix | — |
| | 104810-48-2 | | | | |
| | 25322-68-3 | | | | |
| Tinuvin ® 171 | 125304-04-3 | BTZ | liquid | 395 | — |
| Tinuvin ® 328 | 25973-55-1 | BTZ | solid | 352 | 79-83 |
| Tinuvin ® 384-2 | 127519-17-9 | BTZ | liquid | 452 | — |
| Tinuvin ® 900 | 70321-86-7 | BTZ | solid | 448 | 138-142 |
| Tinuvin ® 99-2 | 127519-17-9 | BTZ | liquid | 452 | — |
| Tinuvin ® 326 | 11/5/3896 | BTZ-Cl | solid | 316 | 138-142 |
| Tinuvin ® 928 | 73936-91-1 | BTZ | solid | 442 | 109-113 |
| Tinuvin ® Carboprotect ® | proprietary | BTZ | solid | 560 | 132-136 |
| 2-hydroxyphenyl-s-triazine | | | | | |
| based UV absorbers | | | | | |
| Tinuvin ® 400 | 153519-44-9 | HPT | liquid | 647 | — |
| Tinuvin ® 460 | 208343-47-9 | HPT | solid | 630 | 97-101 |
| Tinuvin ® 479 | 204848-45-3 | HPT | solid | 678 | 39-43 1 |
| Tinuvin ® 405 | 137658-79-8 | HPT | solid | 584 | 73-77 |
| Tinuvin ® 477 | Isomer mix | HPT | liquid | mix | — |
| Tinuvin ® 1577 ED | 147315-50-2 | HPT | solid | 425 | 147-151 |

Other suitable non-water-soluble UV absorbing substances for use in a method described herein may be a Benzotriazole or Triazine compound sold under the trade mark Evenstab by Everspring Chemicals.

In some examples, a printing fluid may comprise a UV absorbing substance which is non-water-soluble but is dispersible in water. For example, a substance from the family of substances sold under the trade name Tinuvin® DW by BASF SE®. In such an example, the printing fluid may be an aqueous printing fluid, such as an aqueous ink. Examples of Tinuvin® DW substances which may be used as a UV absorber which is dispersible in water are shown in Table 2. For substances in Table 2, the average particle size may be less than 250 nm, or less than 200 nm. In column 2 Tinuvin® 99-DW may be described as comprising a multi-purpose BTZ-based substance, Tinuvin® 400-DW may be described as comprising a blue-shifted HPT-based substance and Tinuvin® 477-DW may be described as comprising a red-shifted HPT-based substance.

TABLE 2
Dispersible UV absorbing substance

Tinuvin ® 99-DW
Tinuvin ® 400-DW
Tinuvin ® 477-DW

In some examples, the UV absorbing substance may comprise an optical brightener, or a fluorescent brightener. As referred to herein, an optical brightener or fluorescent brightener is a substance which absorbs UV light and converts a small proportion of the absorbed UV energy into fluorescence energy. An optical brightener may convert the majority of the absorbed UV energy to heat, and may thereby dry a solvent-based printing fluid comprising the optical brightener. A UV absorbing substance which is an optical brightener may in examples be a water-soluble substance.

Examples of optical brighteners, or fluorescent brighteners, which a printing fluid to be dried by a method described herein may comprise are shown below in Table 3. The example UV absorbing substances shown in Table 3 are water-soluble, and may, for example, be used alone or in any combination in an aqueous printing fluid. The compounds in Table are identifiable by their CAS, Chemical Abstracts Service, number. Table 3 shows a structure upon which all of the fluorescent brighteners are based. Columns X and Y denote the respective groups present at the shown X and Y positions for each substance in the table.

TABLE 3

| | 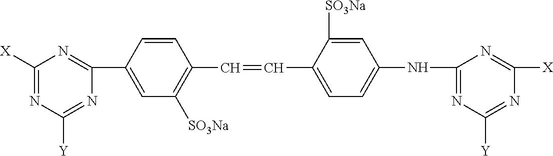 | | | |
|---|---|---|---|---|
| UV | | | | Number of |
| Absorbing | | | | Sulfonic Acid |
| Substance | CAS | X | Y | Groups |
| Fluorescent | 133-66-4 | Phenyl amino | Phenyl amino | 2 |
| Brightener 9 | | | | |
| Fluorescent | 12224-02-1 | Bis(2-hydroxyethyl)amino | 3-sulfophenylamino | 4 |
| Brightener 24 | | | | |
| Fluorescent | 4404-43-7 | Bis(2-hydroxyethyl)amino | Phenyl amino | 2 |
| Brightener 28 | | | | |
| Fluorescent | 16090-02-1 | 4-Morpholino | Phenyl amino | 2 |
| Brightener 71 | | | | |
| Fluorescent | 12224-06-5 | 2-hydroxyethylamino | Phenyl amino | 2 |
| Brightener 85 | | | | |
| Fluorescent | 12768-91-1 | Bis(2-hydroxyethyl)amino | 3-sulfophenylamino | 4 |
| Brightener 87 | | | | |
| Fluorescent | 12768-92-2 | Diethoxyamino | Phenyl amino | 2 |
| Brightener | | | | |
| 113 | | | | |
| Fluorescent | 28950-61-0 | 4-Morpholino | 4-sulfophenylamino | 4 |
| Brightener | | | | |
| 210 | | | | |
| Fluorescent | 16470-24-9 | Bis(2-hydroxyethyl)amino | 4-sulfophenylamino | 4 |
| Brightener | | | | |
| 220 | | | | |
| Fluorescent | 16324-27-9 | 2-hydroxyethylamino | 3-sulfophenylamino | 4 |
| Brightener | | | | |
| 251 | | | | |
| Fluorescent | 76482-78-5 | Bis(2-hydroxyethyl)amino | 2,4-disulfophenylamino | 6 |
| Brightener | | | | |
| 264 | | | | |
| Fluorescent | 41098-56-0 | Diethylamino | 2,4-disulfophenylamino | 6 |
| Brightener | | | | |
| 357 | | | | |

The UV absorbing substances shown in Table 3 may absorb UV light below around 415 nm with an absorption peak of around 350 nm. The substances in Table 3 may also emit light at around 420 nm, i.e. blue light. In some examples, an example UV absorbing substance as shown in Table 3 may act to optically brighten the appearance of a printing substance. For example, where UV light of around 395 nm is used to dry a printing fluid, for example where a 395 nm LED is used, the UV absorbing substance or substances in the printing fluid may absorb 395 nm UV light. Substances absorbing at around 395 nm may give a slightly yellow appearance to the printing fluid. The emitted, blue, light from an optical brightener such as those shown in Table 3, may make the appearance of a printing fluid less yellow, and may make the printing fluid appear clearer. A majority of the energy from UV light absorbed by a substance in Table 3 may be converted to heat, to dry a printing fluid. An example UV absorbing substance shown in Table 3 may have a peak of absorption coefficient at around 350 nm and high absorption for the waveband of radiation emitted by a 395 nm LED.

The substances in Table 3 may be water-soluble, and may have a high solubility in water. In examples, the solubility in water of substances containing 4 or more sulfonic groups may be particularly high. In examples, an aqueous ink may comprise around 5-7.5% of a substance in Table 3, or 5-7.5% in aggregate of more than one substance in Table 3. In an example method, an aqueous ink comprising this level of UV substance may be printed in a layer comprising around 3 drops per pixel and 600 pixels per inch, where each drop may have a mass of around 6 ng. Such a layer may, in examples, absorb around 90% of UV light, for example 90% of light from a 395 nm LED, with which it is irradiated. In some examples, a binding agent, such as a salt, may be used for retaining the UV absorbing substance on the surface of the media, to allow absorption of UV light by the absorbing substance. In some examples, the bonding agent may be printed onto media before the clear printing fluid.

Table 4 shows an example composition for a printing fluid which may be used in an example method described herein.

TABLE 4

| Ingredients | Amount (% by weight) |
|---|---|
| Fluorescent Brightener | 7.5 |
| 24 | |
| Colorant | 0-4.5 |
| Binder | 0-10 |
| 1,2-Butanediol | 8 |
| 2-pyrrolidone | 2 |
| Dowanol TPM | 2 |
| Crodafos N-3 Acid | 0.5 |
| Surfynol 440 | 0.15 |
| Dynol 360 | 0.15 |
| Acticide M20 | 0.15 |
| Acticide B20 | 0.08 |
| Water | Balance |
| | 100% |

In examples, a printing fluid according to Table 4 is a clear fluid which does not comprise a colorant. In some examples a printing fluid according to Table 4 may not comprise a binder. An example printing fluid according to Table 4 may be an aqueous printing fluid which is capable of being delivered by an ink jet printer, for example by a thermal ink jet print head.

An example printing fluid may comprise: water, or at least one organic solvent material, or mixtures thereof, with these compositions being present in varied proportions in accordance with preliminary pilot testing. As used herein, a solvent is a substance that carries other substances in a printing fluid in a homogeneous and uniform manner. Likewise, the solvent may also inherently function as a humectant, namely, a moisture-retaining agent, with the term solvent being construed to encompass materials added for solvent purposes, humectant purposes, or for both purposes. Example organic solvents suitable for use in an example printing fluid comprising water, which may be considered co-solvents, include tripropyleneglycol monomethyl ether—TPM, ethoxylated glycerol; diethylene glycol; tetraethylene glycol; 1,2-hexanediol; 1,2-butanediol, 1,2-propanediol; glycerol, 2-pyrrolidone; 2-hydroxyethylpyrrolidone; 2-propanol; 2-ethyl-2-hydroxymethyl-1,3-propanediol; and mixtures thereof. In some examples an example printing fluid may comprise at least about 30% by weight water. An example printing fluid may contain about 60-87% by weight water and about 10-37% by weight of one or more organic solvents.

An example printing fluid may comprise a biocide which may be added to prevent any microbial growth in the printing fluid. Examples of biocides which may be suitable for this purpose include proprietary products sold under the trademarks Acticide M20 and Acticide B20. If a biocide is used, the printing fluid may contain about 0.05-0.5% by weight biocide, or about 0.30% by weight.

An example printing fluid may comprise a surfactant material or materials which are designed to provide beneficial surface tension and homogeneity characteristics in the printing fluid. An example surfactant material which may be used is that sold under the name Crodafos N-3 Acid by Croda, Inc. of Parsippany, N.J. USA, which comprises a material consisting of oleth-3 phosphate or polyoxyethylene (3) oleyl ether phosphate (acid). Where an example printing fluid comprises a surfactant, the printing fluid may comprise around 0.1-3% by weight total, combined, surfactant.

An example printing fluid may have an average viscosity of about 1.0-5.0 centipoise, with a surface tension of about 30-45 dynes/cm although these values are subject to variation in accordance with the specific materials that are selected to produce the printing fluid.

In some examples described herein, a substantially clear solvent-based fluid may comprise any one, or any number of UV absorbing substances, for example any one or any number of the substances for which spectra are represented in FIG. 3 or one or more UV absorbing substances shown in Tables 1, 2, or 3. As described above, the type of UV absorbing substances included in a printing fluid may be dependent on the type of solvent or solvents included in the printing fluid. In examples, any suitable substance which is capable of absorbing light in the UV range of the electromagnetic spectrum may be present in the printer fluid as a UV absorber. In some examples, a UV absorbing substance present in the printing fluid may transmit light in the visible range, for example above approximately 420 nm, as will be discussed in more detail below. A UV absorbing substance present in the clear solvent-based printing fluid may, in examples, be a substance which is soluble, or which is capable of being suspended in the printer fluid.

In some examples, the substantially clear solvent-based printer fluid is for a thermal inkjet printing apparatus and comprises: approximately 10-30% solids, such as waxes, latex, and/or other binders; approximately 5-30% co-solvents, such as glycols and/or water; and approximately 1-10%, or approximately 3% UV absorbing substances. In another example the solvent-based printer fluid may not contain water and may contain other solvents. In another example, the printer fluid may contain 50-70% water.

The radiation with which the layer is irradiated may be chosen to provide at least a minimum absorption efficiency for a given UV absorbing substance present in the printer fluid. For example, a radiation absorption efficiency of at least 30%, 45%, 50%, 55%, 60%, 65%, 70% or at least 75% for any one of, or some of, or all of the UV absorbing substances which the printer fluid comprises. In examples, an absorption efficiency of at least 75% is achieved by the UV absorbing substances, and in examples, the concentration of UV absorbing substances in a printer fluid layer of approximately 10 μm is between around 2% and 4.5%.

For some UV absorbing substances, this may mean irradiating the substrate with a waveband of radiation having a central wavelength between around 200 nm and 410 nm. In some examples, a UVA light source having a waveband of around 315 nm-400 nm may be used. In some examples, a UVB light source having a waveband of around 280 nm-315 nm may be used. In some examples, both UVA and UVB light sources may be used. In some examples, the waveband of radiation is approximately 365 nm-395 nm. In some examples, the waveband of radiation may be controlled or selected based on an absorption characteristic of a UV light absorbing substance present in the printer fluid. In examples, where there is more than one UV absorbing substance in the printer fluid, the waveband of radiation with which the printer fluid is irradiated to dry it may be controlled or selected based on an absorption characteristic of one or of more than one of the UV absorbing substances present in the printer fluid.

For an LED with a waveband of approximately 365 nm-395 nm, maximal energy absorption efficiencies of greater than around 30% or greater than around 50% may be achieved for example UV absorbing substances HPT-1, HPT-2, BTZ-1 and BTZ-2, as can be seen from FIG. 3. For the same waveband, maximal energy absorption efficiencies of greater than 90% may be achieved for HPT-2 and BTZ-2, as again may be seen from FIG. 3.

As mentioned above, in some examples, the same UV light source may be used for drying colored printer fluids and clear printer fluids. For a 395 nm LED, energy absorption efficiencies of over 90% are achieved in Cyan, Yellow and Black while Magenta absorbs energy with around 75% efficiency. For an LED with a waveband of approximately 365 nm-395 nm, the absorption efficiencies for colored inks are relatively balanced, with less than 25% separating the different colorant absorption efficiencies. Absorption efficiencies are also relatively balanced for this waveband between the aforementioned colored inks and example UV absorbing substances, such as HPT-2 and BTZ-2. This means, for example, that the difference in heating of colored and clear printed fluids is relatively small, and the fluid will dry in similar timeframes, mitigating overheating which may result if inks dry over very different timeframes.

In examples where a plurality of printing fluids is used, for example comprising clear and colored fluids or a plurality of clear fluid comprising different UV absorbing substances, the absorption efficiencies for each of the printing fluids used may differ by less than a predetermined amount, for example 30%, 20%, 15%, 10% or 5%. In some examples, the absorption efficiencies may lie within a range such that overheating and/or damage due to overheating of a substrate underlying the fluid with the highest absorption efficiency is unlikely or prevented before the fluid with the lowest absorption efficiency is dry.

In some examples, the UV radiation used is relatively close to the visible range since the waveband may be around 295 nm-405 nm, which borders visible radiation. In examples where the substrate being printed on reflects UV light, for example where the substrate is an opaque substantially white substrate such as paper, a high percentage, for example around 95%, of non-absorbed UV light may be reflected from the substrate surface. The reflected UV light may then travel back through the printer fluid layer, which allows for further absorption of the UV light by the printer fluid. This may be contrasted with IR radiation, which tends to penetrate, rather than be reflected by, a substrate and may be absorbed by moisture in a porous substrate such as cardboard or paper. Use of UV therefore reduces heating to the substrate, which in turn can reduce warping in a substrate. This effect is supplemented as the absorption of UV radiation in water is low, in addition to being reflected and thereby improving efficiency of absorption, so heating of the substrate is low. In examples, UV light absorbing substances are used which allow substantial transmittance of visible light, to allow for the above-discussed reflection and further absorption. With reference to FIG. 3, it can be seen that the example ultraviolet light absorbing substances for which transmittance spectra are plotted have high transmittances for visible light, above approximately 420 nm.

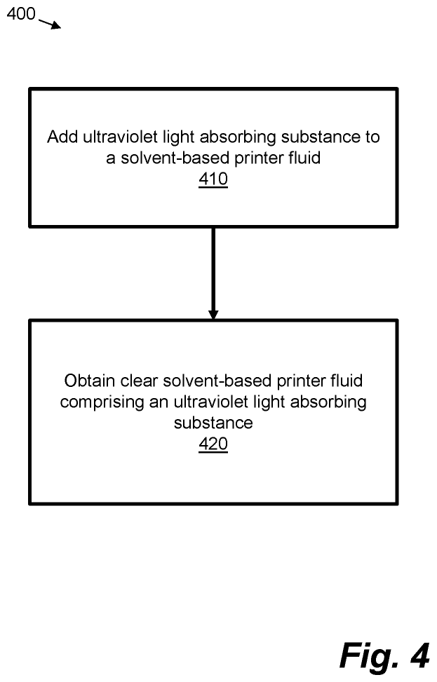

FIG. 4 is a flowchart of an example method 400 comprising at block 410 adding an ultraviolet light absorbing substance to a solvent-based printer fluid. The ultraviolet light absorbing substance may be, for example, any of the substances discussed above, with reference to FIG. 3, or any of the other UV absorbing substances described herein, for example those included in Table 1, Table 2, or Table 3, in some examples dependent on the type of printing fluid. The method 400 may be performed to provide the clear solvent-based printer fluid of the method 200, and therefore in some examples the method 200 may comprise method blocks 410 and 420. The solvent-based printer fluid may comprise any suitable solvent, such as example solvents described herein, and the UV light absorbing substance may be added, for example, to a substantially clear solvent-based fluid. The fluid to which the UV light absorbing substance is added may be a printer fluid or a precursor to a printer fluid, for example, the fluid may be a coating, a primer or a varnish or a precursor to any of these. In examples, the UV light absorbing substance or substances may be added during manufacture of a substantially clear solvent-based printer fluid. In some examples, the UV light absorbing substance may be added by a printing substance distribution unit.

In examples, the UV absorbing substance or substances which are added to a printing fluid or printing fluid precursor may be selected based on their absorbance and/or transmittance spectra. In some examples, the UV absorbing substance or substances to be added may be chosen based on at least one other printer fluid which the clear fluid is to be used with. For example, the UV absorbing substance added may be selected such that the absorption efficiency of the clear fluid and the absorption efficiency of colored printing fluids to be printed in the same print operation are within a predetermined range of absorption efficiencies. For example, where the colored printing fluids to be used in a print operation have absorption efficiencies of between 50% and 60%, the type and amount of UV absorbing substance added to the clear fluid may be such that the clear fluid has a resulting UV absorption efficiency of between 50% and 60%.

A cartridge may be provided for use with a printer, wherein the cartridge comprises a substantially clear solvent-based printing substance comprising a UV absorbing substance for use in an example method described herein. In some examples, the UV absorbing substance may be added to the clear printing substance by the print apparatus.

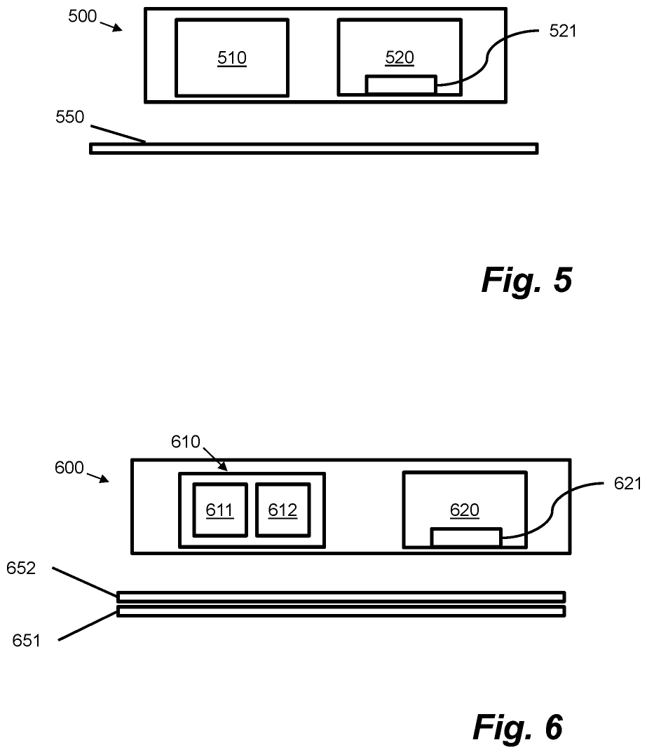

FIG. 5 shows an example print apparatus 500 comprising a dryer unit 520 which comprises at least one ultraviolet light source 521 to evaporate solvent from a substantially clear printer fluid comprising an ultraviolet light absorbing substance. In examples, the solvent may include water, and/or a glycol or the like. The print apparatus 500 comprises a printing substance distribution unit 510. The printing substance distribution unit 510 in examples is for distributing print fluid as a layer 550 of print fluid on a substrate (not shown).

In the example of FIG. 5, a substrate (not shown) is conveyed from a position under the printing substance distribution unit 510 to the dryer unit 520 to dry the printer fluid, the substrate for example being conveyed by a moving belt (not shown). In examples, the print apparatus may be an ink jet printer, a xerographic printer, an offset printer, a flexographic printer, a gravure printer, or any other digital or analogue printer.

The light source 521 may comprise an ultraviolet light emitting diode (LED), for example a 300 nm LED, a 375 nm LED, a 395 nm LED or a 410 nm LED. In other examples, the light source 521 may comprise, for example, a laser diode or other laser device. In an example, the ultraviolet light emitted from the light source 521 is such that an absorption efficiency for the light is higher for the ultraviolet absorber than for the solvent. The dryer unit 520 in examples causes evaporation of solvent from a clear printer fluid comprising at least one ultraviolet absorbing substance, wherein the heating of the solvent is substantially due to heat transfer from the ultraviolet light absorbing substance. Examples of the ultraviolet absorbing substance, also referred to ultraviolet light absorber, are discussed above.

In some examples a UV light source may be used to irradiate a solvent-based printer fluid comprising a pigment, in addition to irradiating the substantially clear solvent-based printer fluid comprising a UV absorber.

FIG. 6 shows an example print apparatus 600 comprising a printing substance distribution unit 610. The printing substance distribution unit 610 comprises a first distribution unit 611 for printing colored print fluids, such as colored aqueous inks, and comprises a second distribution unit 612 for printing clear solvent-based print fluids, such as one or more of a primer, a coating or a varnish. In the example of FIG. 6, a printed first layer 651 of colored print fluid and a printed second layer 652 of clear print fluid is shown. The print apparatus 600 comprises a dryer unit 620 which causes evaporation of solvent, such as water or an organic solvent, from the colored printer fluid, in addition to causing evaporation from the clear printing fluid. The heating of the solvent fluid is substantially due to heat transfer from the colorant in the case of the colored fluid and is substantially due to heat transfer from the UV light absorber in the case of the clear fluid. In some examples, the light source 621 emits light in a relatively narrow band, for example, having a bandwidth of around 20 nm-30 nm, in the UV range. In some examples, the light source 621 has a central frequency between 200 nm-400 nm.

The first printing substance distribution unit 611 may dispense at least one printing substance comprising a colorant, for example a pigment or a dye. In this example, the first printing substance distribution unit 611 is to dispense cyan C, magenta M, yellow Y and black K colorants dissolved or suspended in water, for example forming an aqueous ink. In some examples, printing substances comprising colorants such as orange, green and violet may be dispensed by the printing substance distribution unit. In some examples, the colorants may be dissolved or suspended in a different solvent, such as one or more organic solvents described herein, or the aqueous ink may comprise further co-solvents, such as one or more glycols.

In examples, the UV light source 621 of the dryer unit 620 may comprise an array of ultraviolet light emitting diodes. For example, the UV light source 621 may comprise light emitting diodes in an array which are selected or controlled to emit light in a portion of the electromagnetic spectrum absorbed by the ultraviolet light absorbing substance or substances present in the printer fluids dispensed by distribution unit 610, such that evaporation of solvent from the solvent-based printing substance is caused by heat transfer from the ultraviolet light absorbing substance or substances. For example, each LED in the array may by controlled to selectively emit or not emit light or to control the amount of light emitted based on the printing fluids used in a particular print apparatus, or for a particular printing operation. In some examples a UV light source 621 which may vary the wavelength and/or waveband of the light it emits may be used and this wavelength and/or waveband may be controlled or selected based on printing fluids used by the print apparatus 600. In some examples, the array of light emitting diodes may comprise diodes which emit radiation in a bandwidth selected from within the wavelength range 300 nm-450 nm, or 365 nm-395 nm. In examples, the bandwidth of each LED may be around 20 nm-30 nm.

In examples, one or more light sources may be selected or controlled to emit a waveband which is effective at drying the fluids being, or to be, printed. For example, the most efficient waveband for drying the ultraviolet light absorbing substance present in the clear printing fluid may be identified and used to control or instruct the choice of light source. In some examples, the most efficient waveband for drying the colors such as Cyan, Yellow, Magenta, Orange, Green, Violet and so on, may be identified and used to control or instruct the choice of light source, and in some examples, this may be in addition to the identifying of the most efficient waveband for drying the clear fluid. In some examples, the waveband(s) of light emitted may be controlled or selected according to drying efficiency and/or providing a relatively balanced drying time for the inks and other printer fluids applied or anticipated in a particular print operation.

Although examples in the present disclosure have been described with reference to a clear printer fluid comprising a UV absorbing substance, it should be understood that the method of drying a solvent-based printer fluid with a UV light is applicable to other solvent-based printer fluids comprising a UV absorbing substance. For example, an example method may comprise adding to a solvent-based printer fluid, which may be a non-clear printer fluid such as a colored aqueous ink, a substance which absorbs a particular wavelength of UV light. In such examples, the added UV absorber may be chosen to achieve a particular absorption efficiency for the printer fluid to which it is added, for example to achieve an absorption efficiency for the printer fluid within a given range of other printer fluids to be dried by the same UV light source.

The present disclosure is described with reference to flow charts and/or block diagrams of the method, devices and systems according to examples of the present disclosure. Although the flow diagram described above show a specific order of execution, the order of execution may differ from that which is depicted.

The preceding description has been presented to illustrate and describe certain examples. Different sets of examples have been described; these may be applied individually or in combination for a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

The features of any dependent claim may be combined with the features of any of the independent claims or other dependent claims. Features described in relation to one example may be combined with features of another example.

What is claimed is:

1. A method comprising:
applying to a substrate a layer of substantially clear solvent-based printer fluid comprising an ultraviolet light absorbing substance; and
irradiating the layer of printer fluid with ultraviolet light to heat the solvent and cause evaporation of the solvent;
wherein the waveband of radiation is such that heating of the solvent is substantially due to heat transfer from the ultraviolet light absorbing substance.

2. The method according to claim 1 wherein the solvent comprises water and the ultraviolet light absorbing substance is a water-soluble substance.

3. The method according to claim 2 wherein the ultraviolet light absorbing substance is a fluorescent brightener.

4. The method according to claim 1 wherein the solvent comprises water and the ultraviolet light absorbing substance is a substance which is dispersible in water.

5. The method according to claim 1 wherein the solvent comprises an organic solvent and the ultraviolet light absorbing substance is a substance which is not substantially soluble in water.

6. The method according to claim 1 comprising irradiating the layer with radiation having an absorption efficiency of at least 30% for the ultraviolet light absorbing substance.

7. The method according to claim 1 comprising selecting or controlling the waveband of radiation according to the identity of at least one ultraviolet light absorbing substance present in the printer fluid.

8. The method according to claim 1 wherein irradiating the layer of printer fluid comprises irradiating the layer of printer fluid with ultraviolet light from an ultraviolet light emitting diode.

9. The method according to claim 1 comprising irradiating the printing substance with a waveband of radiation which is between 300 nm and 420 nm or between 365 nm and 395 nm.

10. The method according to claim 1 further comprising:
adding to a solvent-based printer fluid an ultraviolet light absorbing substance, to produce the substantially clear solvent-based printer fluid.

11. The method according to claim 10, comprising adding a plurality of ultraviolet light absorbing substances to the solvent-based printing fluid to produce the substantially clear-solvent based printer fluid.

12. Print apparatus comprising a printing substance distribution unit and a dryer unit, the printing substance distribution unit being to dispense a substantially clear solvent-based printing substance comprising an ultraviolet absorber, and the dryer unit comprising at least one ultraviolet light source, the light source being to emit light in a portion of the electromagnetic spectrum absorbed by the ultraviolet absorber, such that evaporation of solvent fluid from the solvent-based printing substance is caused by heat transfer from the ultraviolet absorber.

13. Print apparatus according to claim 12 which comprises an ink jet print apparatus.

14. Print apparatus according to claim 12 in which the printing substance distribution unit is to dispense a plurality of printing substances, the plurality of printing substances comprising the substantially clear solvent-based printing substance and at least one colored printing substance.

15. Print apparatus according to claim 14 in which the light source is to emit light in a portion of the electromagnetic spectrum which is absorbed by both the substantially clear printing substance and at least one of the at least one colored printing substances, wherein, for the emitted light, the maximal energy absorption efficiency of the clear printing substance and the maximal energy absorption efficiency for each of the colorants differ by no more than 30%.

16. Print apparatus according to claim 12, in which the light source comprises at least one light emitting diode, the or each of the light emitting diode emitting radiation in a bandwidth within the range 200 nm-450 nm, and the radiation having a bandwidth of around 30 nm.

17. Print apparatus according to claim 14 in which the light source is to emit light in a portion of the electromagnetic spectrum which is absorbed by both the substantially clear printing fluid and at each of the at least one colorants with a radiation absorption efficiency of at least 30%.
